(19) United States
(12) Patent Application Publication
(10) Pub. No.: US 2010/0296881 A1
(43) Pub. Date: Nov. 25, 2010

(54) Universal Cutter Structure

(76) Inventor: Kuo-Chen HUANG, Hemei Township (TW)

Correspondence Address: Jackson Intellectual Property Group PLLC, 106 Starvale Lane, Shipman, VA, 22971, US

(21) Appl. No.: 12/471,356

(22) Filed: May 23, 2009

(51) Int. Cl. B23C 5/22

(52) U.S. Cl. 407/47

(57) ABSTRACT

A universal cutter structure includes a double-headed screw made of tungsten steel or steel. The double-headed screw has outer threads at front and rear sections thereof and a positioning block at a middle section thereof. The front and rear sections of the double-headed screw are screwed to an upper threaded trough of a cutter rod and a lower threaded trough of a cutter head, respectively. The positioning block engages with the cutter rod and the cutter head directly or indirectly such that the parts are tightened to be a one-piece cutter. When the double-headed screw is removed, the cutter rod is able to be coupled with a screw and a positioning block provided at a distal end of the cutter head. The present invention provides a better steadiness for processing and is convenient for replacement.

### BACKGROUND OF THE INVENTION

1. Field of the Invention

The present invention relates to a universal cutter structure, and more particularly to one having a double-headed screw with its two ends screwed to threaded troughs of a cutter rod and a cutter head, and a positioning block provided at a middle section of the double-headed screw to fix the cutter rod and the cutter head in place directly or indirectly for changing a new cutter head. The cutter rod is able to be coupled with a screw and a positioning block provided on the cutter head for decreasing cost.

2. Description of the Prior Art

There are three types of cutters on the market. One is formed integrally, which has a better quality and steadiness. However, it is required to replace a whole cutter when the head of this cutter is worn. This is not cost-effective. The other two types of cutters comprise a screw which is welded with a cutter rod or a cutter head. When the head of the cutter is worn, it is required to replace a new cutter head only. This is cot-effective. However, the junction of these two types of cutters is easily broken due to great strike force. In addition, the junction may become deformed after a period of time, which is unable to engage with each other tightly and decreases its service life. Besides, these two types of cutters are not replaceable. When replacing a new cutter head, it must correspond to a specific cutter rod. This is inconvenient in use.

### SUMMARY OF THE INVENTION

The primary object of the present invention is to provide a universal cutter structure, which provides a double-headed screw having outer threads at front and rear sections thereof and a positioning block at a middle section thereof, a cutter rod having an upper threaded trough and an upper positioning trough at a front end thereof, and a pair of upper cutting troughs at two sides thereof; and a cutter head having a lower threaded trough and a lower positioning trough at a distal end thereof, and a pair of cutting troughs at two sides thereof. The front and rear sections of the double-headed screw are screwed to the cutter rod and the cutter head, respectively, for securing the cutter rod and the cutter head to the positioning block of the double-headed screw directly or indirectly. The cutter structure of the present invention is durable and has a long service life.

A second object of the present invention is to provide a universal cutter structure, which provides a cutter rod having an upper threaded trough to engage with a screw and a positioning block provided on a distal end of a conventional cutter head when the double-headed screw is removed. The front edge surface of the cutter rod and the upper positioning trough are contact with the distal edge surface of the conventional cutter head and fixed to the positioning block directly. By screwing the upper cutting troughs and the cutting portions at the two sides of the cutter rod and the cutter head, respectively, the cutter rod and the conventional cutter head are tightened to be one-piece for providing a convenient assembly with the conventional cutter head.

### BRIEF DESCRIPTION OF THE DRAWINGS

FIG. 1 is an exploded view of a first preferred embodiment of the present invention;

FIGS. 1A to 1C are assembled views of the first preferred embodiment of the present invention;

FIG. 2 is an exploded view of a second preferred embodiment of the present invention;

FIGS. 2A to 2C are assembled views of the second preferred embodiment of the present invention;

FIG. 3 is an exploded view of the present invention and a conventional cutter head; and

FIGS. 3A to 3C are assembled views of the present invention and the conventional cutter head.

### DETAILED DESCRIPTION OF THE PREFERRED EMBODIMENTS

Embodiments of the present invention will now be described, by way of example only, with reference to the accompanying drawings.

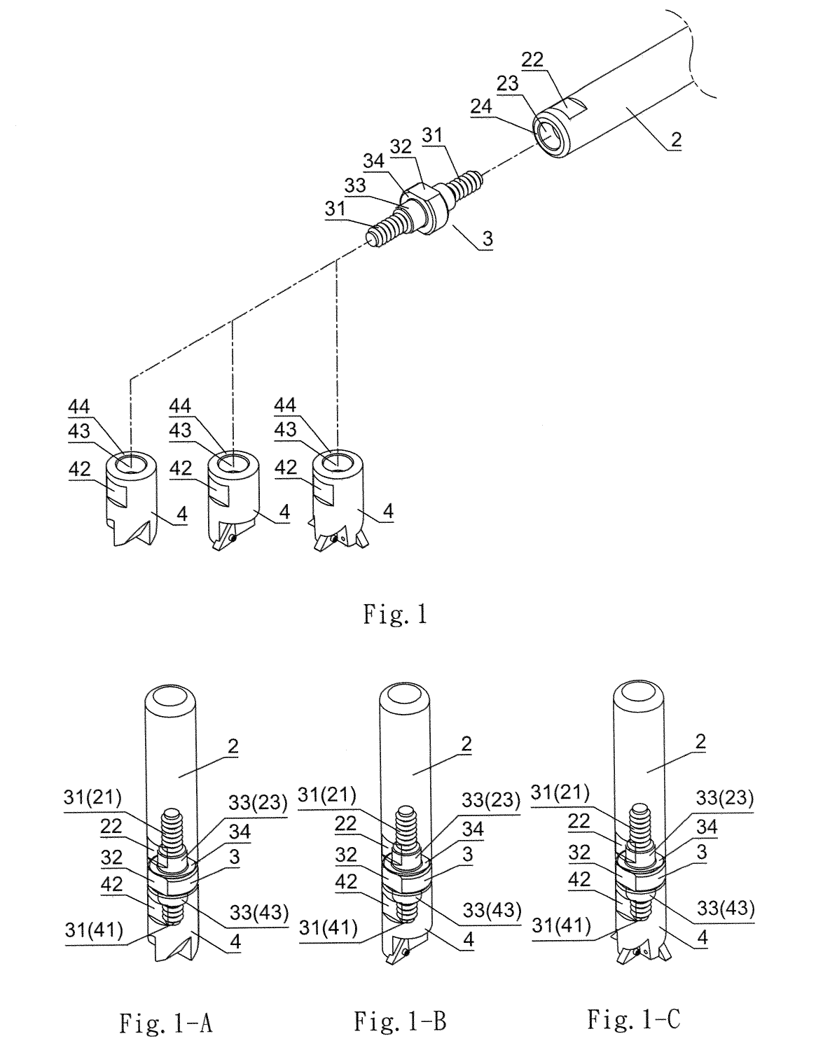

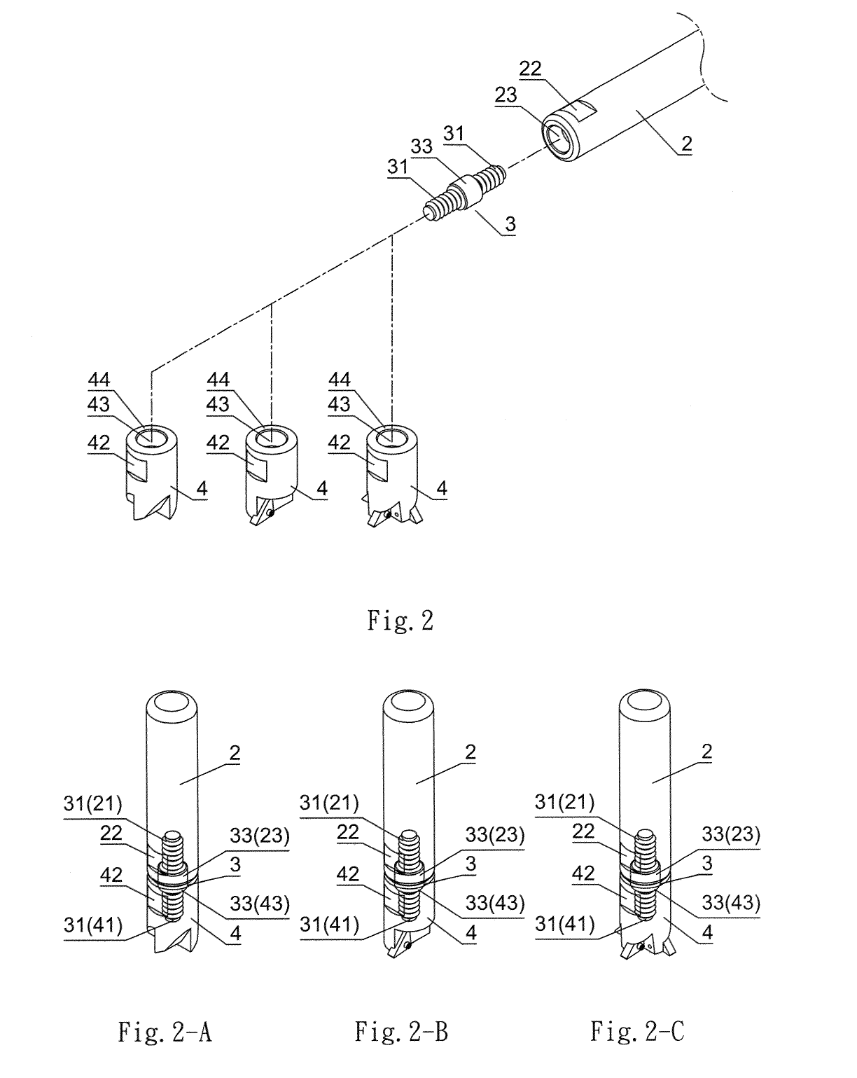

As shown in FIGS. 1 and 2, the present invention comprises a cutter rod 2, a double-headed screw 3, and a cutter head 4.

The cutter rod 2 made of tungsten steel comprises an upper threaded trough 21 and an upper positioning trough 23 at a front end thereof for connecting with a rear section of the double-headed screw 3, and a pair of upper cutting troughs 22 at two sides thereof for assisting in screwing.

The double-headed screw 3 made of tungsten steel has outer threads 31 at front and rear sections thereof and a positioning block 33 at a middle section thereof. The double-headed screw 3 may be a straight screw or a cross-shaped screw. In this embodiment, the double-headed screw 3 is a cross-shaped screw having a pair of cutting portions 32 at two sides of the positioning block 33 for assisting in screwing.

The cutter head 4 made of tungsten steel comprises a lower threaded trough 41 and a lower positioning trough 43 at a distal end thereof, and a pair of cutting troughs 42 at two sides thereof for assisting in screwing. Accordingly, the present invention provides a tight engagement among the parts.

FIGS. 1 and 1A to 1C show a first embodiment of the present invention. The double-headed screw 3 is a cross-shaped screw. The upper threaded trough 21 of the cutter rod 2 and the lower threaded through 41 of the cutter head 4 engage with the outer threads 31 at the front and rear sections of the double-headed screw 3, respectively. The upper positioning through 23 of the cutter rod 2 with its front edge surface and the lower positioning trough 43 of the cutter head 4 with its distal edge surface abut against the positioning block 33 with its upper and lower edge surfaces of for securing the cutter rod 2 and the cutter head 4 in position indirectly. By screwing the upper cutting troughs 22, the cutting portions 32, and the lower cutting troughs 42, the cutter rod 2, the double-headed screw 3 and the cutter head 4 are tightened to be one-piece for providing a better steadiness.

FIGS. 2 and 2A to 2C show a second embodiment of the present invention. The double-headed screw 3 is a straight screw. The upper threaded trough 21 of the cutter rod 2 and the lower threaded through 41 of the cutter head 4 engage with the outer threads 31 at the front and rear sections of the double-headed screw 3, respectively. The upper positioning through 23 of the cutter rod 2 A with its front edge surface and the lower positioning trough 43 of the cutter head 4 with its distal edge surface abut against the positioning block 33 for securing the cutter rod 2 and the cutter head 4 in position directly. By screwing the upper cutting troughs 22 and the lower cutting troughs 42, the cutter rod 2, the double-headed screw 3 and the cutter head 4 are tightened to be one-piece for providing a better steadiness.

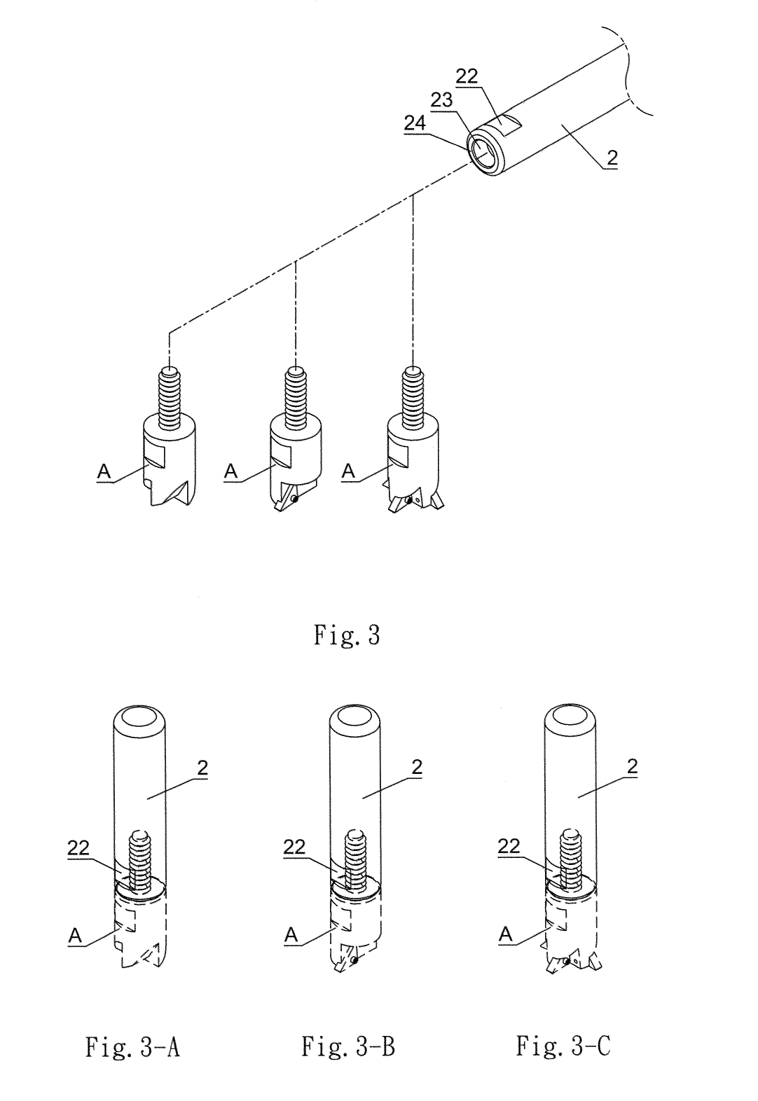

As shown in FIGS. 3 and 3A to 3C, the cutter rod 2 is able to be coupled with a conventional cutter head A when the double-headed screw 3 is removed. The upper threaded trough 21 of the cutter rod 2 is screwed to a screw and a positioning block provided at a distal end of the conventional cutter head A. Furthermore, the front edge surface of the cutter rod 2 and the upper positioning trough 23 are contact with the distal edge surface of the conventional cutter head A and fixed to the positioning block directly. By screwing the upper cutting troughs 22 and cutting portions at the two sides of the cutter rod 2 and the cutter head A respectively, the cutter rod 2 and the conventional cutter head A are tightened to be one-piece for providing a convenient assembly with the conventional cutter head.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A universal cutter structure, comprising a cutter rod and a cutter head, a front end of the cutter rod being formed with an upper threaded trough and an upper positioning trough, a distal end of the cutter head being formed with a lower threaded trough and a lower positioning trough, and characterized by: the universal cutter structure further comprising a double-headed screw, the double-headed screw comprising outer threads at front and rear sections thereof and a positioning block at a middle section thereof, the front and rear sections of the double-headed screw being screwed to the upper threaded trough of the cutter rod and the lower threaded trough of the cutter head, respectively, for securing the cutter rod and the cutter head to the positioning block of the double-headed screw directly or indirectly.

2. The universal cutter structure as claimed in claim 1, wherein the double-headed screw is made of tungsten steel.

3. The universal cutter structure as claimed in claim 1, wherein the front end of the cutter rod and the distal end of the cutter head are formed with cutting troughs at two sides thereof, respectively, for assisting in screwing.

4. The universal cutter structure as claimed in claim 1, wherein the cutter rod is directly screwed to a screw provided at the distal end of the cutter head for replacement of the cutter head.

5. The universal cutter structure as claimed in claim 1, wherein the double-headed screw is either of a straight screw and a cross-shaped screw.

6. The universal cutter structure as claimed in claim 5, wherein the cross-shaped screw has cutting portions at two sides of the middle section for assisting in screwing.
